(19) United States
(12) Patent Application Publication
(10) Pub. No.: US 2025/0355157 A1
(43) Pub. Date: Nov. 20, 2025

(54) LIGHT SOURCE DEVICE AND DISPLAY DEVICE

(71) Applicant: Japan Display Inc., Tokyo (JP)

(72) Inventor: Junji KOBASHI, Tokyo (JP)

(21) Appl. No.: 19/095,619

(22) Filed: Mar. 31, 2025

(30) Foreign Application Priority Data
May 14, 2024 (JP) 2024-078618

(51) Int. Cl. F21V 8/00; G02F 1/1334; G02F 1/13357

(52) U.S. Cl. CPC G02B 6/0023; G02B 6/0068; G02F 1/1334; G02F 1/1336

(57) ABSTRACT

According to one embodiment, a display device includes a first transparent substrate, a second transparent substrate which has a first surface and a second surface different from the first surface, a liquid crystal layer which is located between the first transparent substrate and the second transparent substrate and contains a polymer dispersed liquid crystal, a light emitting unit configured to emit illumination light for illuminating the liquid crystal layer, and a diffractive optical element which faces the first surface, is provided at a position which does not overlap the liquid crystal layer, and is configured to diffract the illumination light.

### CROSS-REFERENCE TO RELATED APPLICATIONS

This application is based upon and claims the benefit of priority from Japanese Patent Application No. 2024-078618, filed May 14, 2024, the entire contents of which are incorporated herein by reference.

### FIELD

Embodiments described herein relate generally to a light source device and a display device.

### BACKGROUND

Recently, various types of display devices which use a polymer dispersed liquid crystal which can switch between a scattered state and a transparent state have been suggested. For example, a display device comprises a display panel comprising a polymer dispersed liquid crystal, and a light source provided along a side surface of a transparent substrate. In this display device, the luminance tends to decrease with increasing distance from the light source, and thus, the improvement of uniformity of luminance is required.

In the meantime, a technique which guides an image displayed at a position distant from the user and projects the image on the eyes of the user is known.

### BRIEF DESCRIPTION OF THE DRAWINGS

FIG. 1 is a plan view showing configuration example 1 of a display device 1.

FIG. 2 is the cross-sectional view of the display device 1 along the A-B line of FIG. 1.

FIG. 3 is a diagram for explaining a state in which part of illumination light LI is diffracted.

FIG. 4 is a plan view showing configuration example 2 of the display device 1.

FIG. 5 is a plan view showing configuration example 3 of the display device 1.

FIG. 6 is a diagram for explaining a diffractive optical element OF which can be applied to configuration example 3.

FIG. 7 is a diagram for explaining another diffractive optical element OE which can be applied to configuration example 3.

FIG. 8 is a plan view showing configuration example 4 of the display device 1.

FIG. 9 is a plan view showing configuration example 5 of the display device 1.

FIG. 10 is a plan view showing configuration example 6 of the display device 1.

FIG. 11 is the cross-sectional view of the display device 1 along the A-B line of FIG. 10.

FIG. 12 is a plan view showing configuration example 7 of the display device 1.

FIG. 13 is a plan view showing configuration example 8 of the display device 1.

FIG. 14 is a plan view showing configuration example 9 of the display device 1.

FIG. 15 is a diagram showing the light guide LG shown in FIG. 14.

FIG. 16 is a plan view showing configuration example 10 of the display device 1.

FIG. 17 is a plan view showing configuration example 11 of the display device 1.

FIG. 18 is a plan view showing configuration example 12 of the display device 1.

FIG. 19 is a cross-sectional view showing a configuration example of the diffractive optical element OE.

FIG. 20 is a diagram for explaining application example 1 of a liquid crystal element.

FIG. 21 is a diagram for explaining application example 2 of a liquid crystal element.

FIG. 22 is a diagram for explaining application example 3 of a liquid crystal element.

FIG. 23 is a diagram for explaining application example 4 of a liquid crystal element.

FIG. 24 is a cross-sectional view showing a configuration example of the display device 1 along the C-D line of FIG. 1.

FIG. 25 is a cross-sectional view showing another configuration example of the display device 1 along the C-D line of FIG. 1.

FIG. 26 is a plan view showing modified example 1.

FIG. 27 is a plan view showing modified example 2.

FIG. 28 is a plan view showing modified example 3.

FIG. 29 is a plan view showing modified example 4.

FIG. 30 is a plan view showing modified example 5.

### DETAILED DESCRIPTION

In general, according to one embodiment, a display device comprises a first transparent substrate, a second transparent substrate which has a first surface and a second surface different from the first surface, a liquid crystal layer which is located between the first transparent substrate and the second transparent substrate and contains a polymer dispersed liquid crystal, at least one light emitting unit configured to emit illumination light for illuminating the liquid crystal layer, and a diffractive optical element which faces the first surface, is provided at a position which does not overlap the liquid crystal layer, and is configured to diffract the illumination light.

According to another embodiment, a light source device comprises a transparent substrate having a first surface and a second surface different from the first surface, a light emitting unit configured to emit illumination light for illuminating the transparent substrate, and a diffractive optical element facing the first surface and configured to diffract the illumination light.

Embodiments will be described with reference to the accompanying drawings.

The disclosure is merely an example, and proper changes in keeping with the spirit of the invention, which are easily conceivable by a person of ordinary skill in the art, come within the scope of the invention as a matter of course. In addition, in some cases, in order to make the description clearer, the widths, thicknesses, shapes, etc., of the respective parts are illustrated schematically in the drawings, rather than as an accurate representation of what is implemented. However, such schematic illustration is merely exemplary, and in no way restricts the interpretation of the invention. In addition, in the specification and drawings, structural elements which function in the same or a similar manner to those described in connection with preceding drawings are denoted by like reference numbers, detailed description thereof being omitted unless necessary.

In the drawings, in order to facilitate understanding, an X-axis, a Y-axis and a Z-axis orthogonal to each other are shown depending on the need. A direction parallel to the X-axis is referred to as a first direction X. A direction parallel to the Y-axis is referred to as a second direction Y. A direction parallel to the Z-axis is referred to as a third direction Z. When various elements are viewed parallel to the third direction Z, the appearance is defined as a plan view. When terms indicating the positional relationships of two or more structural elements, such as “on”, “above” “between” and “face”, are used, the target structural elements may be directly in contact with each other or may be spaced apart from each other as a gap or another structural element is interposed between them. The positive direction of the Z-axis is referred to as “on” or “above”.

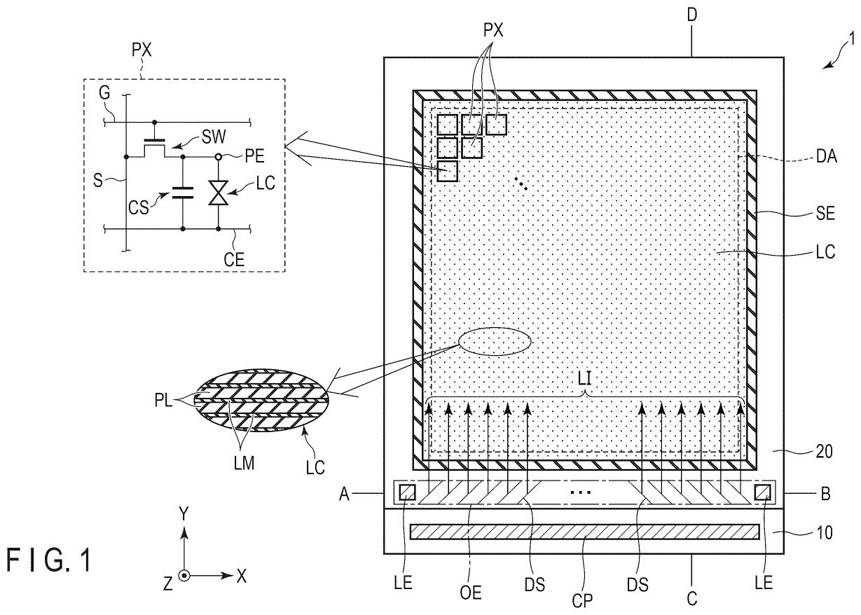

FIG. 1 is a plan view showing configuration example 1 of a display device 1.

The display device 1 comprises a transparent substrate 10, a transparent substrate 20, a liquid crystal layer CL, a sealant SE, light emitting units LE and a diffractive optical element OE. Each of the transparent substrate 10 and the transparent substrate is formed into a plate-like shape parallel to an X-Y plane defined by a first direction X and a second direction Y, and they overlap each other in plan view. The transparent substrate 10 is extended in the second direction Y further compared to the transparent substrate 20. In the example shown in the figure, each of the transparent 10 and the transparent substrate 20 is formed into a rectangle. However, the shapes are not limited to this example. For example, each of the transparent substrate 10 and the transparent substrate may have any shape different from a rectangle, such as a polygon, a circle, an oval or a semicircle.

The liquid crystal layer LC is located between the transparent substrate 10 and the transparent substrate 20 and sealed with the sealant SE. In the example schematically shown in an enlarged view of FIG. 1, the liquid crystal layer LC comprises a polymer dispersed liquid crystal containing polymers PL and liquid crystal molecules LM. For example, the polymers PL are liquid crystalline polymers and formed into a streaky shape which extends in the first direction X. The liquid crystal molecules LM are dispersed in the gaps of the polymers PL, and are aligned such that the long axes are parallel to the first direction X. Each of the polymers PL and the liquid crystal molecules LM has optical anisotropy or refractive anisotropy. The responsiveness of the polymers PL for an electric field is lower than that of the liquid crystalline molecules LM for an electric field.

For example, the alignment direction of the polymers PL does not substantially change regardless of the presence or absence of an electric field. To the contrary, the alignment direction of the liquid crystal molecules LM changes based on the electric field in a state where a high voltage greater than or equal to a threshold is applied to the liquid crystal layer LC. In a state where no voltage is applied to the liquid crystal layer LC, the optical axes of the polymers PL are parallel to those of the liquid crystal molecule LM, and the light which entered the liquid crystal layer LC is not substantially scattered inside the liquid crystal layer LC and passes through the liquid crystal layer LC (transparent state). In a state where voltage is applied to the liquid crystal layer LC, the optical axes of the polymers PL intersect with those of the liquid crystal molecules LM, and the light which entered the liquid crystal layer LC is scattered inside the liquid crystal layer LC (scattered state).

It should be noted that the configuration of the polymer dispersed liquid crystal containing the polymers PL and the liquid crystal molecules LM is not limited to the example described above.

The display device 1 has a display area DA which displays images. The display area DA comprises a plurality of pixels PX arrayed in matrix in the first direction X and the second direction Y. In the example shown in the figure, the display area DA is formed into the rectangle indicated by broken lines. However, the shape is not limited to this example. For example, the display area DA may have any shape different from a rectangle, such as a polygon, a circle, an oval or a semicircle.

As shown in an enlarged view of FIG. 1, each pixel PX comprises a switching element SW, a pixel electrode PE, a common electrode CE, a liquid crystal layer LC, etc. The switching element SW consists of, for example, a thin-film transistor (TFT), and is electrically connected to a scanning line G and a signal line S. The scanning line G extends in the first direction X, and is electrically connected to the switching element SW in each of pixels PX arranged in the first direction X. The signal line S extends in the second direction Y, intersects with the scanning line G and is electrically connected to the switching element SW in each of pixels PX arranged in the second direction Y. The pixel electrode PE is electrically connected to the switching element SW. Each pixel electrode PE faces the common electrode CE, and drives the liquid crystal layer LC (in particular, liquid crystal molecules LM) by the electric field generated between the pixel electrode PE and the common electrode CE. For example, capacitance CS is formed between an electrode having the same potential as the common electrode CE and an electrode having the same potential as the pixel electrode PE.

The scanning line G, the signal line S, the switching element SW and the pixel electrode PE are formed between the transparent substrate 10 and the liquid crystal layer LC. The common electrode CE is formed between the transparent substrate 20 and the liquid crystal layer LC.

An IC chip CP and a flexible printed circuit (not shown) are mounted on the transparent substrate 10.

The light emitting units LE are configured to emit illumination light LI with which the liquid crystal layer LC is illuminated. In configuration example 1, the light emitting units LE face the transparent substrate 20 and overlap the transparent substrate 20 in plan view.

The diffractive optical element OE is provided at a position where it does not overlap the liquid crystal layer LC. In configuration example 1, the diffractive optical element OE faces the transparent substrate 20 and overlaps the transparent substrate 20 and the light emitting units LE in plan view. The diffractive optical element OE and the liquid crystal layer LC are arranged in the second direction Y in plan view.

In the example shown in the figure, two light emitting units LE are arranged across an intervening space in the first direction X. The diffractive optical element OE is formed into a belt-like shape which extends in the first direction X. The two light emitting units LE overlap the both end portions of the diffractive optical element OE in plan view. It should be noted that the number of light emitting units LE may be one.

The diffractive optical element OE is configured to diffract illumination light LI emitted from the light emitting units LE. Hereinafter, in the diffractive optical element OE, lattice planes which are arranged with a constant pitch are referred to as diffractive surfaces DS. In the diffractive optical element OE, the diffractive surfaces DS diffract part of illumination light LI. The diffractive surfaces DS located on an end side of the diffractive optical element OE (in the figure, the left side) incline in a direction different from that of the diffractive surfaces DS located on the other end side of the diffractive optical element OE (in the figure, the right side).

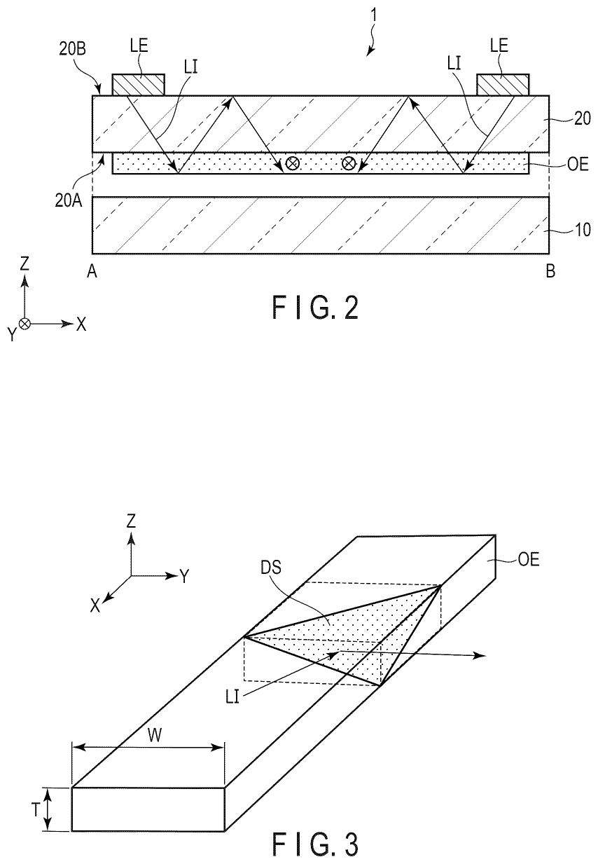

FIG. 2 is the cross-sectional view of the display device 1 along the A-B line of FIG. 1.

The transparent substrate 20 has a main surface 20A which faces the transparent substrate 10 in a third direction Z, and a main surface 20B located on a side opposite to the main surface 20A.

The diffractive optical element OE faces the main surface 20A in the third direction Z. The diffractive optical element OF is, for example, a thin film which is directly formed on the main surface 20A. It should be noted that the diffractive optical element OE may be formed as a sheet and attached to the main surface 20A. An air layer is interposed between the diffractive optical element OE and the transparent substrate 10.

The light emitting units LE face the main surface 20B in the third direction Z. These light emitting units LE comprise light emitting elements and are configured to emit illumination light LI toward the transparent substrate 20. Each of the two light emitting units LE faces the diffractive optical element OE via the transparent substrate 20 in the third direction Z. In the example shown in the figure, each light emitting unit LE emits illumination light LI in an oblique direction relative to the normal of the main surface 20B. These light emitting units LE can be realized by adding a light control element (for example, various types of optical elements such as a diffractive element) which controls the traveling direction of light emitted from the light emitting elements.

Illumination light LI emitted from each light emitting unit LE enters the transparent substrate 20, and subsequently propagates through the stacked body of the transparent substrate 20 and the diffractive optical element OE while repeating total reflection. Subsequently, part of illumination light LI is diffracted so as to be parallel to the second direction Y in the diffractive optical element OE.

FIG. 3 is a diagram for explaining a state in which part of illumination light LI is diffracted.

In the example shown in the figure, the diffractive optical element OE extends in the first direction X, has width W parallel to the second direction Y and has thickness T parallel to the third direction Z. In this diffractive optical element OE, the diffractive surface DS is an inclined surface which intersects with all of the first direction X, the second direction Y and the third direction Z. In the diffractive optical element OE, illumination light LI which propagated parallel to the first direction X is diffracted parallel to the second direction Y on the diffractive surface DS. As explained with reference to FIG. 1, since the diffractive optical element OE and the liquid crystal layer LC are arranged in the second direction Y, the liquid crystal layer LC can be illuminated with illumination light LI which was diffracted in the second direction Y on the diffractive surface DS.

The direction of the diffractive surface DS can be freely set. In addition, the diffraction efficiency in the diffractive optical element OE can be freely set. For this reason, illumination light LI having a desired luminance can be diffracted in a desired direction. Therefore, regardless of the shape of the transparent substrate 20 or the shape of the display area DA, a desired amount of illumination light LI reaches the entire display area DA. Thus, the uniformity of luminance can be improved.

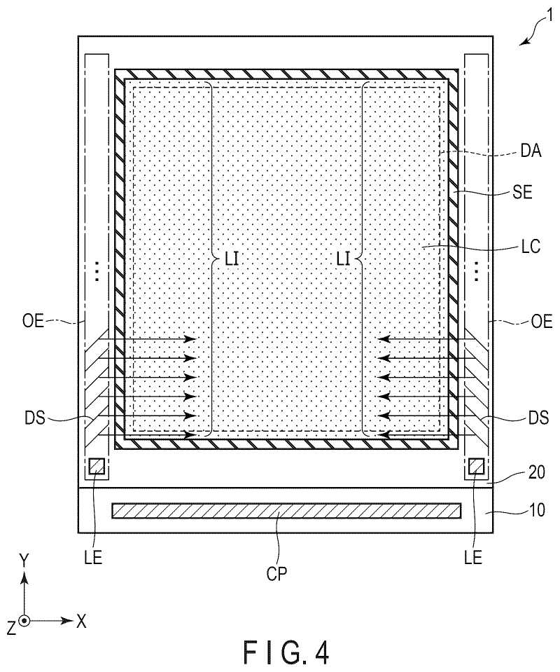

FIG. 4 is a plan view showing configuration example 2 of the display device 1.

Configuration example 2 is different from configuration example 1 in respect that the diffractive optical elements OE extend in the second direction Y.

In a manner similar to that of configuration example 1, the light emitting units LE face the transparent substrate 20 and overlap the transparent substrate 20 in plan view.

The diffractive optical elements OE are provided at positions where they do not overlap the liquid crystal layer LC, face the transparent substrate and overlap the transparent substrate 20 and the light emitting units LE in plan view. The diffractive optical elements OE and the liquid crystal layer LC are arranged in the first direction X in plan view.

In the example shown in the figure, two light emitting units LE are arranged across an intervening space in the first direction X. Two diffractive optical elements OE are arranged across an intervening space in the first direction X. The liquid crystal layer LC is located between the two diffractive optical elements OE in plan view. Each of the two light emitting units LE overlaps an end portion of the corresponding diffractive optical element OE. It should be noted that, in a manner similar to that of configuration example 1, the light emitting units LE may overlap the both end portions of one diffractive optical element OE.

The diffractive surfaces DS of the diffractive optical element OE located on the left side of the figure incline in a direction different from that of the diffractive surfaces DS of the diffractive optical element OE located on the right side of the figure. Illumination light LI emitted from each light emitting unit LE is diffracted in the first direction X on the diffractive surfaces DS when the light reaches the diffractive optical element OE. Thus, the liquid crystal layer LC can be illuminated with illumination light LI.

In this configuration example 2, effects similar to those of configuration example 1 are obtained.

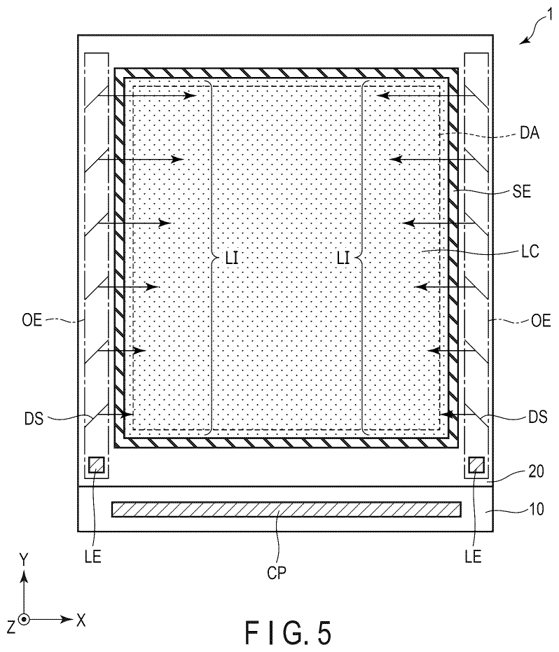

FIG. 5 is a plan view showing configuration example 3 of the display device 1.

Configuration example 3 is different from configuration example 2 in respect that the diffraction efficiency in each diffractive optical element OE differs between an end side and the other end side. In each diffractive optical element OE, the diffraction efficiency in an end portion which overlaps the light emitting unit LE is less than that in the other end portion which does not overlap the light emitting unit LE.

Illumination light LI emitted from each light emitting unit LE tends to attenuate as the light propagates through the transparent substrate 20 (in other words, with increasing distance from the light emitting unit LE).

By applying the diffractive optical elements OE of configuration example 3, the amount of illumination light LI diffracted toward the liquid crystal layer LC is reduced in an end portion where the diffraction efficiency is less, and the amount of illumination light LI which propagates through the transparent substrate 20 is increased toward the other end portion. In this manner, the attenuation of illumination light LI which propagates through the transparent substrate 20 can be controlled, and thus, the uniformity of luminance can be improved.

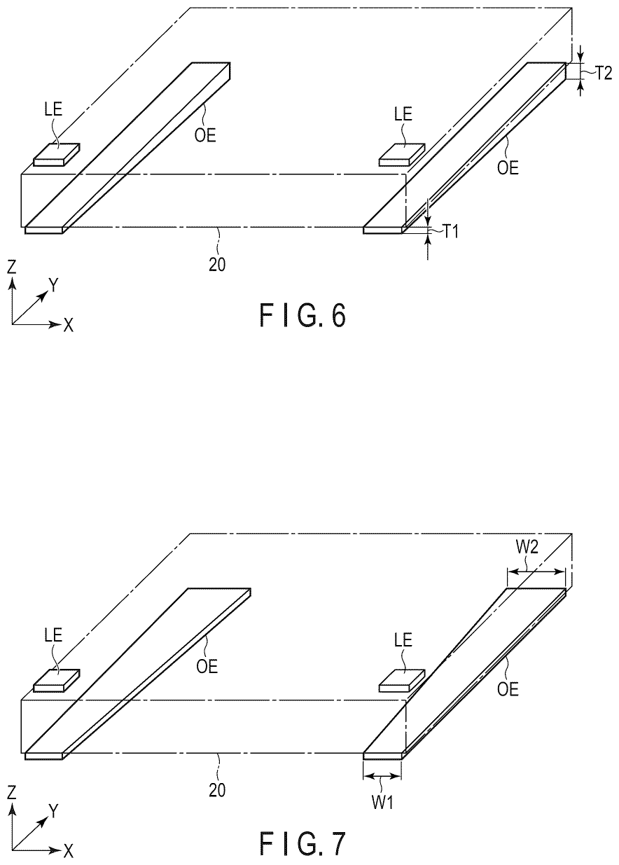

FIG. 6 is a diagram for explaining a diffractive optical element OE which can be applied to configuration example 3.

The diffractive optical element OE extends in the second direction Y and has thickness T parallel to the third direction Z. In the diffractive optical element OE, thickness T1 of an end portion which overlaps the light emitting unit LE is less than thickness T2 of the other end portion which does not overlap the light emitting unit LE (T1<T2). This configuration allows the provision of a diffractive optical element OE in which the diffraction efficiency in an end portion is less than that in the other end portion.

FIG. 7 is a diagram for explaining another diffractive optical element OF which can be applied to configuration example 3.

The diffractive optical element OE extends in the second direction Y and has width W parallel to the first direction X. In the diffractive optical element OE, width W1 of an end portion which overlaps the light emitting unit LE is less than thickness W2 of the other end portion which does not overlap the light emitting unit LE (W1<W2). This configuration allows the provision of a diffractive optical element OE in which the diffraction efficiency in an end portion is less than that in the other end portion.

It should be noted that the configuration is not limited to the examples shown in FIG. 6 and FIG. 7. For example, the diffraction efficiency can be adjusted by the refractive-index distribution in the diffractive optical element OE.

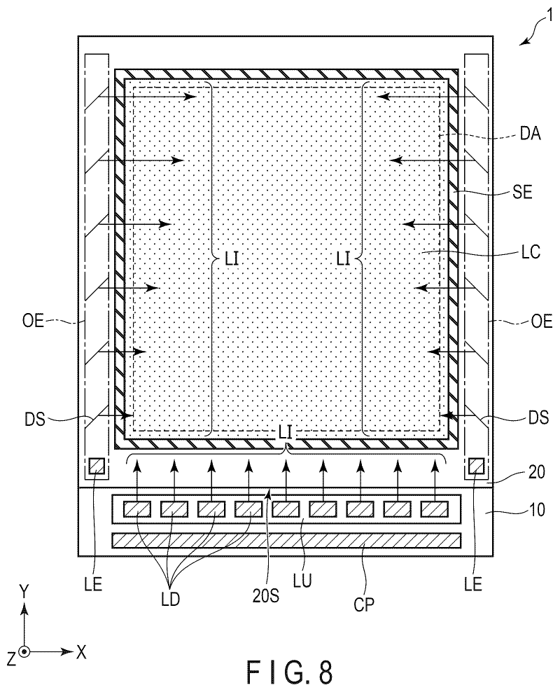

FIG. 8 is a plan view showing configuration example 4 of the display device 1.

Configuration example 4 is different from configuration example 3 in respect that the display device 1 further comprises a light source unit LU. The light source unit LU is provided along, of the transparent substrate 20, a side surface 20S which extends in the first direction X. The light source unit LU comprises a plurality of light emitting elements LD arranged in the first direction X. Each of these light emitting elements LD is configured to emit illumination light LI toward the side surface 20S.

In this configuration example 4, illumination light LI with which the liquid crystal layer LC is illuminated in three directions is formed by two light emitting units LE and the light source unit LU. Thus, the uniformity of luminance in the display area DA can be further improved.

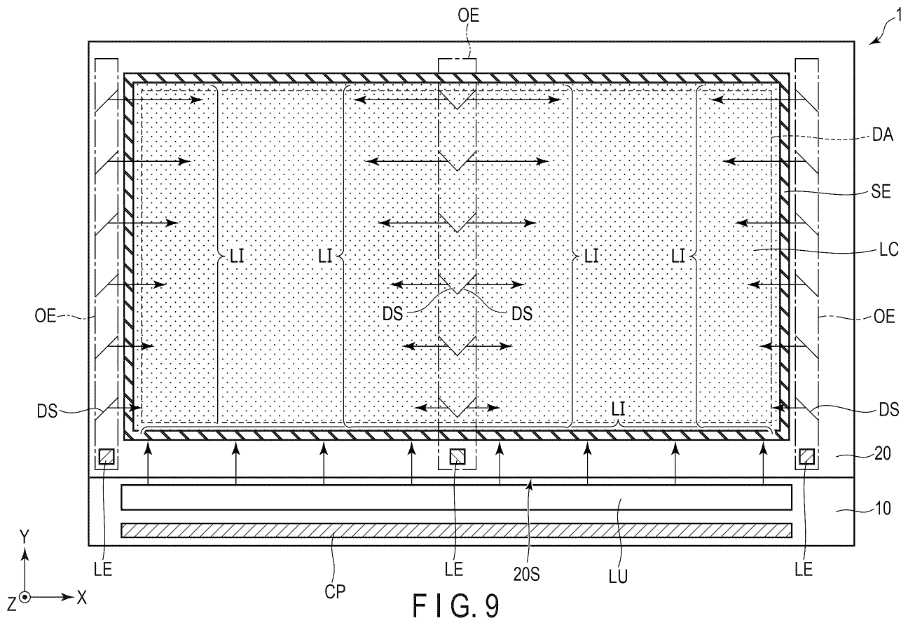

FIG. 9 is a plan view showing configuration example 5 of the display device 1.

In configuration example 5, the display device 1 is formed into a rectangle having long sides in the first direction X. Each of three diffractive optical elements OE is formed into a belt-like shape which extends in the second direction Y. The three diffractive optical elements OE are arranged at intervals in the first direction X. The diffractive optical element OE located in the center intersects with the display area DA or the liquid crystal layer LC in plan view.

In the example shown in the figure, three light emitting units LE are arranged at intervals in the first direction X and overlap end portions of the respective diffractive optical elements OE. It should be noted that the light emitting unit LE located in the center may be omitted. The light source unit LU is provided along the side surface 20S of the transparent substrate 20.

In this display device 1, illumination light LI emitted from the left light emitting unit LE is diffracted to the right side in the diffractive optical element OE. Illumination light LI emitted from the right emitting unit LE is diffracted to the left side in the diffractive optical element OE. Further, illumination light LI emitted from the central light emitting unit LE or the light source unit LU is diffracted to the left side and the right side in the diffractive optical element OE. By this configuration, in the display device 1 having the display area DA which is horizontally long, similarly, the uniformity of luminance can be improved.

In configuration examples 1 to 5 described above, the main surface (first main surface) 20A corresponds to the first surface, and the main surface (second main surface) 20B corresponds to the second surface. Each of the main surfaces 20A and 20B is a surface parallel to an X-Y plane.

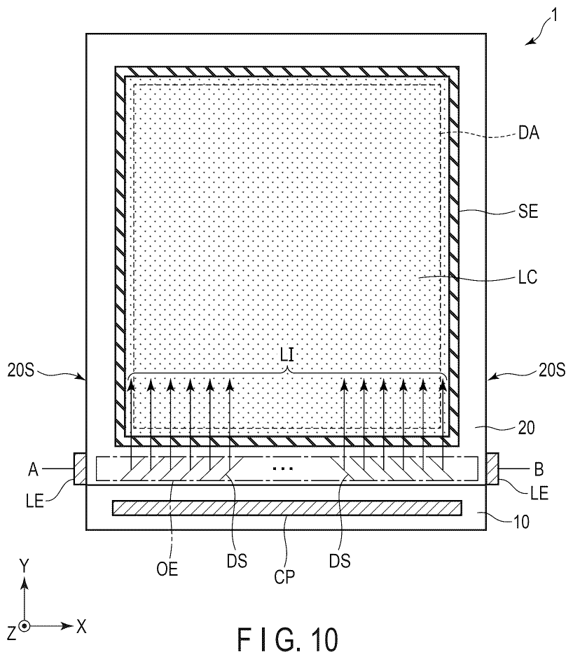

FIG. 10 is a plan view showing configuration example 6 of the display device 1.

Configuration example 6 is different from configuration example 1 in respect that each light emitting unit LE faces the side surface 20S of the transparent substrate 20. In plan view, the diffractive optical element OE overlaps the transparent substrate 20, and the light emitting units LE overlap neither the transparent substrate 20 nor the diffractive optical element OE.

In the example shown in the figure, two light emitting units LE are arranged across an intervening space in the first direction X. The diffractive optical element OE is formed into a belt-like shape extending in the first direction X and is located between the two light emitting units LE. In other words, one of the two light emitting units LE is located on an end side of the diffractive optical element OE, and the other one is located on the other end side of the diffractive optical element OE. It should be noted that the number of light emitting units LE may be one.

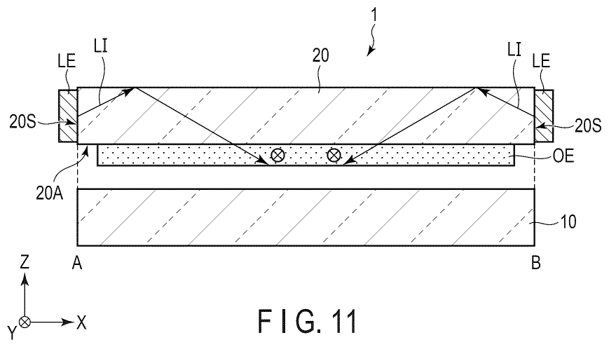

FIG. 11 is the cross-sectional view of the display device 1 along the A-B line of FIG. 10.

The transparent substrate 20 has the main surface 20A which faces the transparent substrate 10 in the third direction Z, and the side surface 20S which intersects with the main surface 20A. Here, the side surface 20S is a surface parallel to a Y-Z plane defined by the second direction Y and the third direction Z.

The diffractive optical element OE faces the main surface 20A in the third direction Z. An air layer is interposed between the diffractive optical element OE and the transparent substrate 10.

The light emitting units LE face the side surfaces 20S in the first direction X and are configured to emit illumination light LI toward the transparent substrate 20. Illumination light LI emitted from each light emitting unit LE enters the transparent substrate 20, and subsequently propagates through the stacked body of the transparent substrate and the diffractive optical element OE while repeating total reflection. Subsequently, part of illumination light LI is diffracted so as to be parallel to the second direction Y in the diffractive optical element OE.

In this configuration example 6, effects similar to those of configuration example 1 described above are obtained.

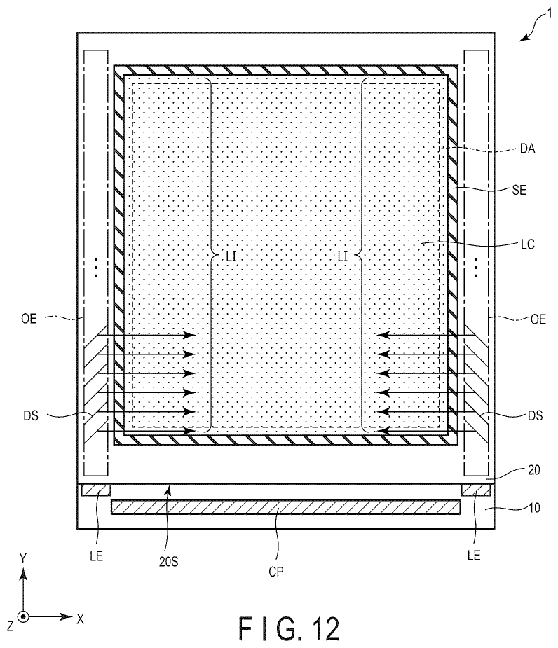

FIG. 12 is a plan view showing configuration example 7 of the display device 1.

Configuration example 7 is different from configuration example 6 in respect that the diffractive optical elements OE extend in the second direction Y.

The light emitting units LE face the side surface 20S of the transparent substrate 20 in the second direction Y. In configuration example 7, the side surface 20S which faces the light emitting units LE is a surface parallel to an X-Z plane defined by the first direction X and the third direction Z.

The diffractive optical elements OE are provided at positions where they do not overlap the liquid crystal layer LC, face the transparent substrate and overlap the transparent substrate 20 in plan view. The diffractive optical elements OE and the liquid crystal layer LC are arranged in the first direction X in plan view.

In the example shown in the figure, two light emitting units LE are arranged across an intervening space in the first direction X. Two diffractive optical elements OE are arranged across an intervening space in the first direction X. The liquid crystal layer LC is located between the two diffractive optical elements OE in plan view. Each of the two light emitting units LE is located on an end side of the corresponding diffractive element OE. It should be noted that, in a manner similar to that of configuration example 6, the light emitting units LE may be located on an end side and the other end side of one diffractive optical element OE.

In this configuration example 7, effects similar to those of configuration example 1 are obtained.

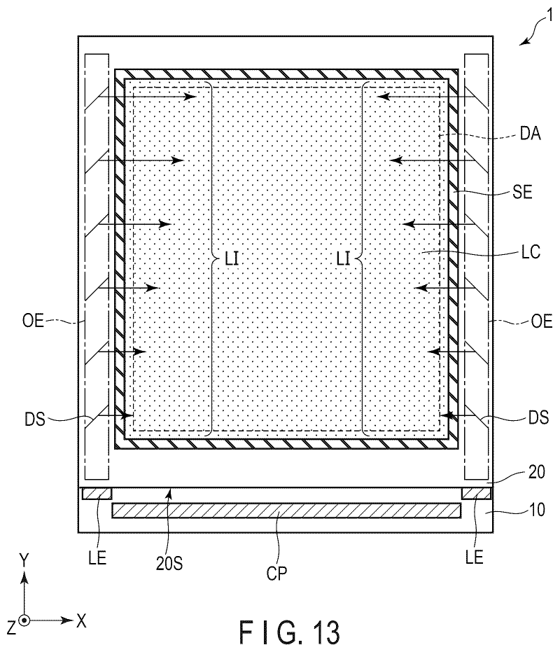

FIG. 13 is a plan view showing configuration example 8 of the display device 1.

Configuration example 8 is different from configuration example 7 in respect that the diffraction efficiency in each diffractive optical element OE differs between an end side and the other end side. In each diffractive optical element OE, the diffraction efficiency in an end portion close to the light emitting unit LE is less than that in the other end portion which is spaced apart from the light emitting unit LE. These diffractive optical elements OE are configured in a manner similar to that of the diffractive optical elements explained in configuration example 3. For example, as explained with reference to FIG. 6, a diffractive optical element OF having a configuration in which thickness T1 of an end portion is less than thickness T2 of the other end portion can be applied. Alternatively, as explained with reference to FIG. 7, a diffractive optical element OE having a configuration in which width W1 of an end portion is less than width W2 of the other end portion can be applied.

In this configuration example 8, similarly, the uniformity of luminance can be improved.

It should be noted that, in configuration example 8, as explained in configuration example 4, the light source unit LU may be further added. Further, as explained in configuration example 5, in a manner similar to that of the display device 1 having the rectangular display area DA, the diffractive optical element OE which intersects with the display area DA may be added.

In configuration examples 6 to 8 described above, the main surface (first main surface) 20A corresponds to the first surface, and the side surface 20S corresponds to the second surface. The main surface 20A is a surface parallel to an X-Y plane. The side surface 20S is a surface parallel to a Y-Z plane in configuration example 6, and is a surface parallel to an X-Y plane in configuration examples 7 and 8.

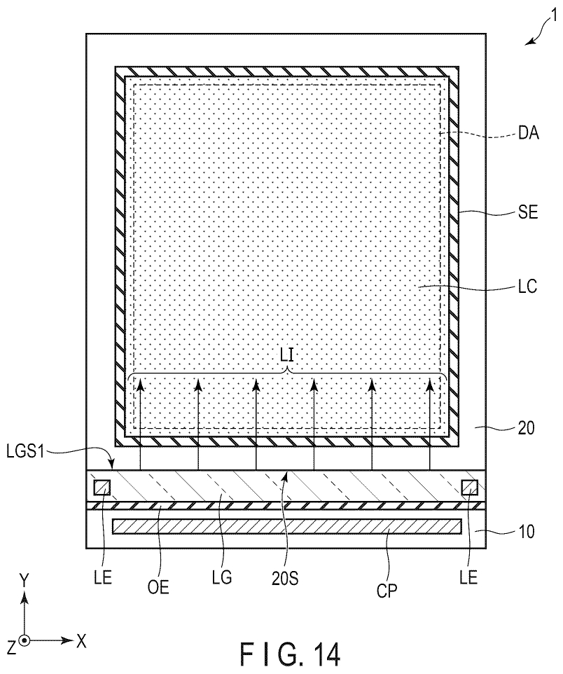

FIG. 14 is a plan view showing configuration example 9 of the display device 1.

In configuration example 9, the display device 1 further comprises a transparent light guide LG. The light guide LG extends in the first direction X and is located between the diffractive optical element OE and the transparent substrate 20 in the second direction Y. The light guide LG is formed of, for example, glass or resin. The light guide LG has a side surface LGS1 which faces the side surface 20S of the transparent substrate 20. For example, the light guide LG is attached to the side surface 20S.

The diffractive optical element OE extends in the first direction X and faces a side surface of the light guide LG in the second direction Y. The diffractive optical element OE faces the side surface 20S of the transparent substrate 20 via the light guide LG. Each light emitting unit LE faces another side surface of the light guide LG. In plan view, the light emitting units LE overlap the both end portions of the light guide LG, and the diffractive optical element OE does not overlap the light guide LG. The light guide LG is explained in detail below.

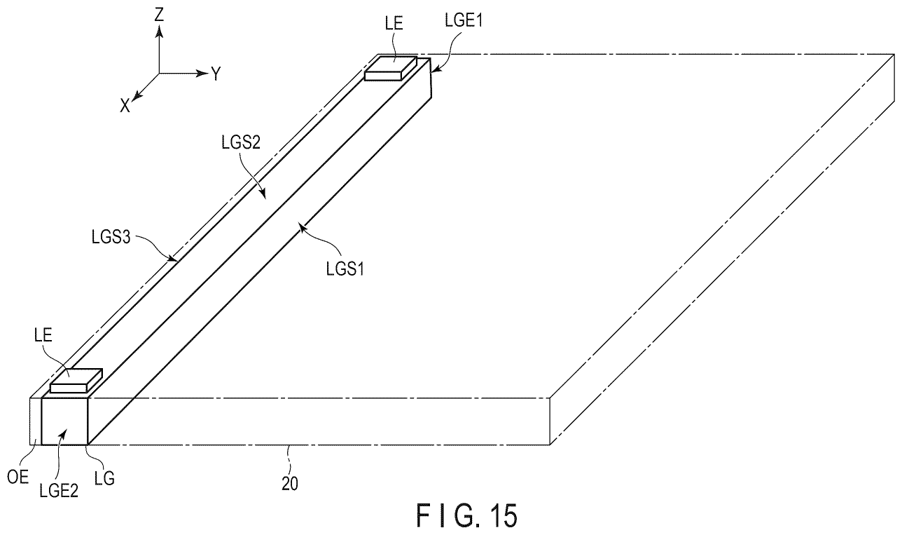

FIG. 15 is a diagram showing the light guide LG shown in FIG. 14.

In addition to the side surface LGS1, the light guide LG has a side surface LGS2, a side surface LGS3, an end surface LGE1 and an end surface LGE2. The side surface LGS2 is a surface which intersects with the side surface LGS1. The side surface LGS3 is a surface facing the side surface LGS1 and intersecting with the side surface LGS2. The end surface LGE1 is a surface intersecting with the side surface LGS1. The end surface LGE2 is a surface facing the end surface LGE1 and intersecting with the side surface LGS1.

In the example shown in the figure, the light guide LG is formed as a rectangular parallelepiped extending in the first direction X. When the side surface LGS1 is a surface parallel to an X-Z plane, the side surface LGS2 is a surface parallel to an X-Y plane, and the side surface LGS3 is a surface parallel to an X-Z plane. The end surface LGE1 and the end surface LGE2 are surfaces parallel to a Y-Z plane.

The diffractive optical element OE faces the side surface LGS3 in the second direction Y. The diffractive optical element OE may be directly formed on the side surface LGS3 or may be attached to the side surface LGS3.

The light emitting units LE face the side surface LGS2 in the third direction Z. In the example shown in the figure, the two light emitting units LE face the both end portions of the side surface LGS2. It should be noted that one light emitting unit LE may face an end portion of the side surface LGS2.

Illumination light emitted from each light emitting unit LE enters the light guide LG and subsequently propagates through the light guide LG while repeating total reflection. Subsequently, part of illumination light is diffracted so as to be parallel to the second direction Y in the diffractive optical element OE.

By this configuration, effects similar to those of configuration example 1 are obtained.

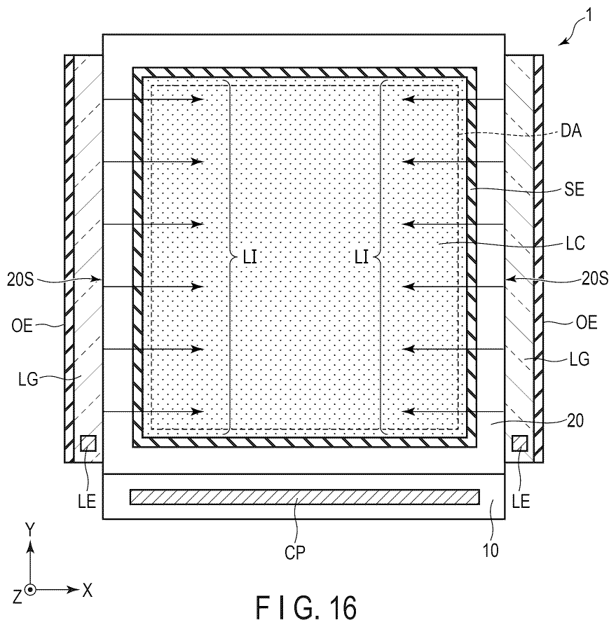

FIG. 16 is a plan view showing configuration example 10 of the display device 1.

Configuration example 10 is different from configuration example 9 in respect that the light guides LG and the diffractive optical elements OE extend in the second direction Y. Each light guide LG is located between the corresponding diffractive optical element OE and the transparent substrate 20 in the first direction X, and for example, is attached to the side surface 20S parallel to a Y-Z plane.

The light emitting units LE face the respective light guides LG and overlap the respective light guides LG in plan view.

In the example shown in the figure, two light emitting units LE are arranged across an intervening space in the first direction X. Two diffractive optical elements OE are arranged across an intervening space in the first direction X. Further, two light guides LG are arranged across an intervening space in the first direction X. The liquid crystal layer LC is located between the two light guides LG in plan view. Each of the two light emitting units LE overlaps an end portion of the corresponding light guide LG. It should be noted that, in a manner similar to that of configuration example 9, the light emitting units LE may overlap the both end portions of one light guide LG.

In this configuration example 10, effects similar to those of configuration example 1 are obtained.

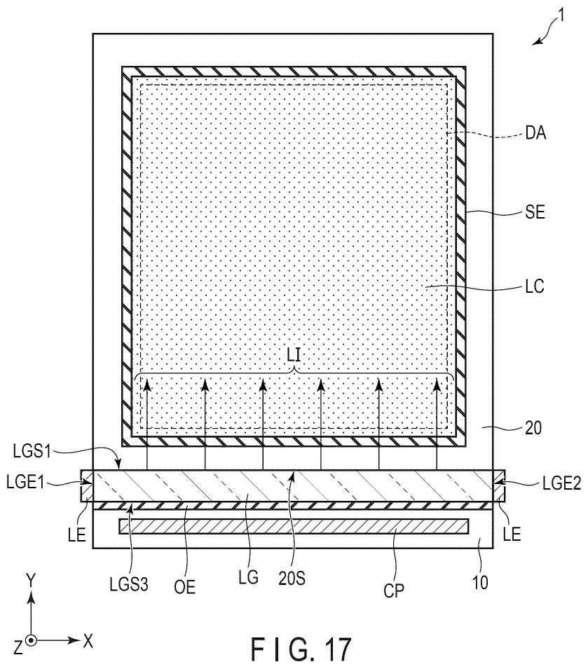

FIG. 17 is a plan view showing configuration example 11 of the display device 1.

Configuration example 11 is different from configuration example 9 in respect that the light emitting units LE face the end surfaces LGE1 and LGE2 of the light guide LG, respectively, in the first direction X. The diffractive optical element OE faces the side surface LGS3 of the light guide LG. In other words, the light guide LG and the diffractive optical element OE are located between the two light emitting units LE.

In this configuration example 11, effects similar to those of configuration example 1 are obtained.

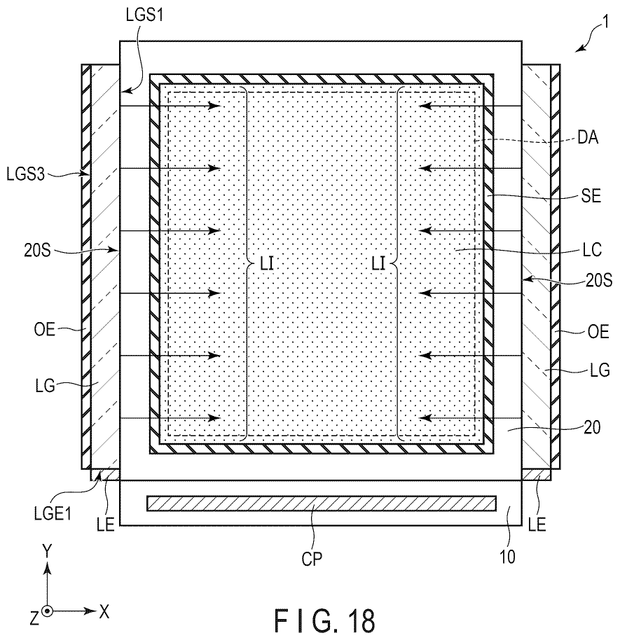

FIG. 18 is a plan view showing configuration example 12 of the display device 1.

Configuration example 12 is different from configuration example 10 in respect that the light emitting units LE face the end surfaces LGE1 of the light guides LG.

In this configuration example, effects similar to those of configuration example 1 are obtained.

In the above configuration examples 9 to 12, each light guide LG is provided between the transparent substrate 20 and the diffractive optical element OE. However, the light guides LG may be omitted, and each diffractive optical element OE may be directly formed on the side surface 20S of the transparent substrate 20 or may be attached to the side surface 20S.

In configuration examples 9 and 10, the side surface LGS2 corresponds to the second surface. In configuration examples 11 and 12, the end surface (first end surface) LGE1 and the end surface (second end surface) LGE2 correspond to the second surface.

Each of the diffractive optical elements OE described above is, for example, a holographic optical element. The holographic optical element has an interference pattern and is configured to diffract part of incident light to a predetermined direction.

Further, each of the diffractive optical elements OE may be a liquid crystal element containing a cholesteric liquid crystal. The cholesteric liquid crystal contains a plurality of liquid crystal molecules which are arranged in a helical fashion unidirectionally twisting. This cholesteric liquid crystal is configured to diffract circularly polarized light having the same direction as the twist direction and transmit circularly polarized light having a direction opposite to the twist direction. The wavelength range of the circularly polarized light diffracted in the cholesteric liquid crystal is set based on the helical pitch and refractive anisotropy of the cholesteric liquid crystal.

In the following descriptions, this specification explains a case where the diffractive optical element OE is a liquid crystal element.

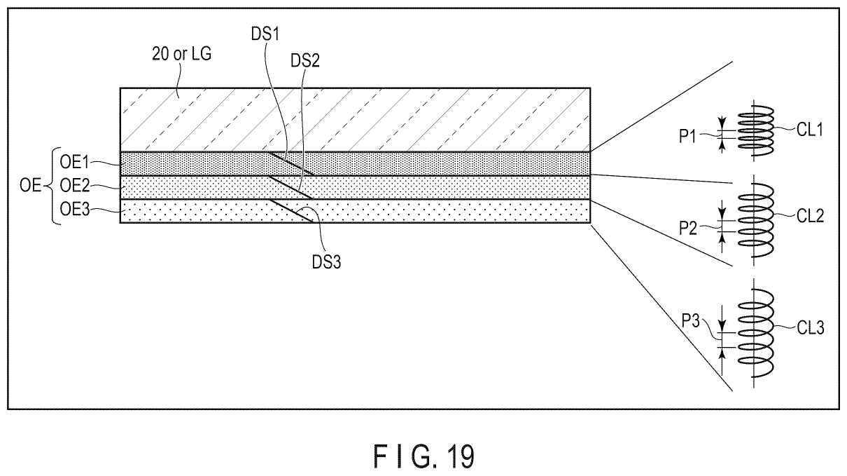

FIG. 19 is a cross-sectional view showing a configuration example of the diffractive optical element OE. It should be noted that FIG. 19 schematically shows, regarding the cholesteric liquid crystal, an enlarged view of a state in which a plurality of liquid crystal molecules are arranged in a helical fashion.

Each of the diffractive optical elements OE explained in the above configuration examples 1 to 12 is, for example, attached to the transparent substrate or the light guide LG. The diffractive optical element OE comprises a diffractive element OE1, a diffractive element OE2 and a diffractive element OE3. The diffractive element OE1, the diffractive element OE2 and the diffractive element OE3 are stacked. It should be noted that the stacking sequence of the diffractive elements is not limited to the example shown in the figure. These diffractive elements OE1, OE2 and OE3 are configured to diffract illumination light having wavelength ranges different from each other.

The diffractive element OE1 contains a cholesteric liquid crystal CL1. The cholesteric liquid crystal CL1 has helical pitch P1. The helical pitch indicates one period of the helix (in other words, the layer thickness parallel to the helical axis and required for a 360-degree rotation of the liquid crystal molecule).

The diffractive element OE2 contains a cholesteric liquid crystal CL2. The cholesteric liquid crystal CL2 has helical pitch P2. Helical pitch P2 is different from helical pitch P1. Here, helical pitch P2 is greater than helical pitch P1 (P1<P2).

The diffractive element OE3 contains a cholesteric liquid crystal CL3. The cholesteric liquid crystal CL3 has helical pitch P3. Helical pitch P3 is different from helical pitch P1 and helical pitch P2. Here, helical pitch P3 is greater than helical pitch P2 (P2<P3).

In the example shown in the figure, all of the cholesteric liquid crystal CL1, the cholesteric liquid crystal CL2 and the cholesteric liquid crystal CL3 twist in the same direction. However, one of them may twist in a direction different from that of the other two.

In the diffractive optical element OE having this configuration, for example, the diffractive element OE1 is configured to diffract, of the incident illumination light, illumination light having a first wavelength range containing a blue component, on a diffractive surface DS1. The diffractive element OE2 is configured to diffract, of illumination light, illumination light having a second wavelength range containing a green component, on a diffractive surface DS2. The diffractive element OE3 is configured to diffract, of illumination light, illumination light having a third wavelength range containing a red component, on a diffractive surface DS3.

When each diffractive element is configured to diffract illumination light having a specific wavelength range in this manner, light of almost all of the ranges of visible light can be diffracted by applying a plurality of diffractive elements in which the wavelength ranges of diffraction are different from each other. In FIG. 19, a case where a plurality of diffractive elements are stacked is explained. However, a plurality of diffractive elements may be arranged in plan view. Further, the diffractive optical element OE may comprise two diffractive elements or may comprise four or more diffractive elements.

Now, this specification explains a case where a liquid crystal element containing a cholesteric liquid crystal is applied as each diffractive optical element OE. Here, a case where a liquid crystal element is applied to the above configuration example 1 is explained. However, as a matter of course, a similar liquid crystal element may be applied to the other configuration examples 2 to 12 as well.

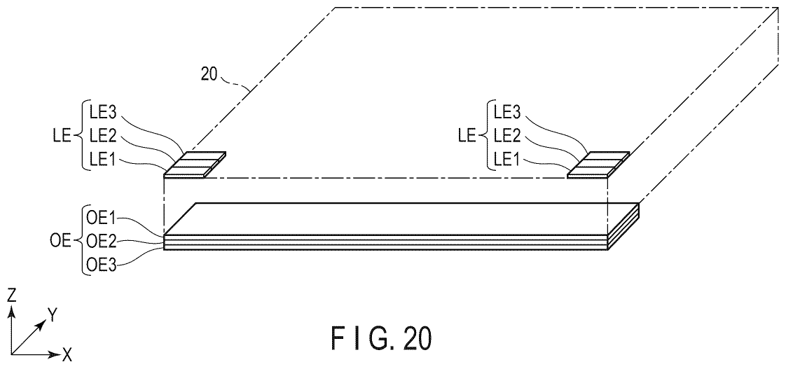

FIG. 20 is a diagram for explaining application example 1 of a liquid crystal element. The transparent substrate 20 is shown by dashed lines.

Each light emitting unit LE comprises a light emitting element LE1, a light emitting element LE2 and a light emitting element LE3. The light emitting element LE1, the light emitting element LE2 and the light emitting element LE3 are provided at positions different from each other without overlapping each other. In the example shown in the figure, they are arranged in the second direction Y. These light emitting elements LE1, LE2 and LE3 are configured to emit illumination light having wavelength ranges different from each other.

For example, the light emitting element LE1 is configured to emit light having the first wavelength range containing a blue component. The light emitting element LE2 is configured to emit light having the second wavelength range containing a green component. The light emitting element LE3 is configured to emit light having the third wavelength range containing a red component.

In the diffractive optical element OE, the diffractive element OE1, the diffractive element OE2 and the diffractive element OE3 are stacked.

Each of the light emitting elements LE1, LE2 and LE3 overlaps the diffractive element OE1, the diffractive element OE2 and the diffractive element OE3 across the intervening transparent substrate 20. In the example shown in the figure, the two light emitting units LE are arranged in the first direction X and overlap the both end portions of the diffractive optical element OE.

Light emitted from the light emitting element LE1 and having the first wavelength range is diffracted on the diffractive element OE1 after passing through the transparent substrate 20. Light emitted from the light emitting element LE2 and having the second wavelength range is diffracted on the diffractive element OE2 after passing through the transparent substrate 20. Light emitted from the light emitting element LE3 and having the third wavelength range is diffracted on the diffractive element OE3 after passing through the transparent substrate 20.

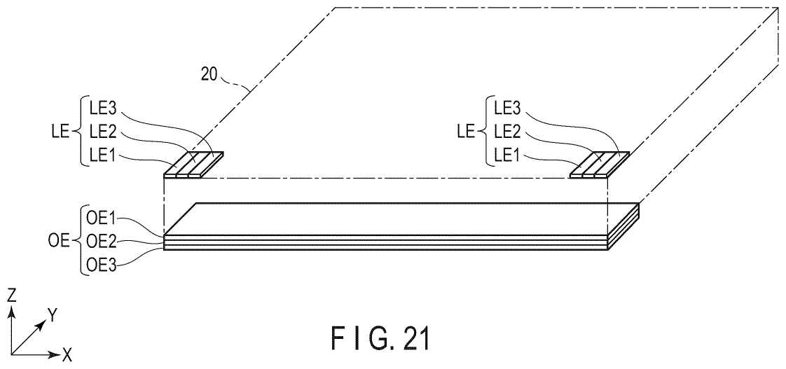

FIG. 21 is a diagram for explaining application example 2 of a liquid crystal element.

Application example 2 is different from application example 1 in respect that the light emitting element LE1, the light emitting element OE2 and the light emitting element LE3 are arranged in the first direction X.

In the diffractive optical element OE, the diffractive element OE1, the diffractive element OE2 and the diffractive element OE3 are stacked.

Each of the light emitting elements LE1, LE2 and LE3 overlaps the diffractive element OE1, the diffractive element OE2 and the diffractive element OE3 across the intervening transparent substrate 20. In the example shown in the figure, the two light emitting units LE are arranged in the first direction X and overlap the both end portions of the diffractive optical element OE.

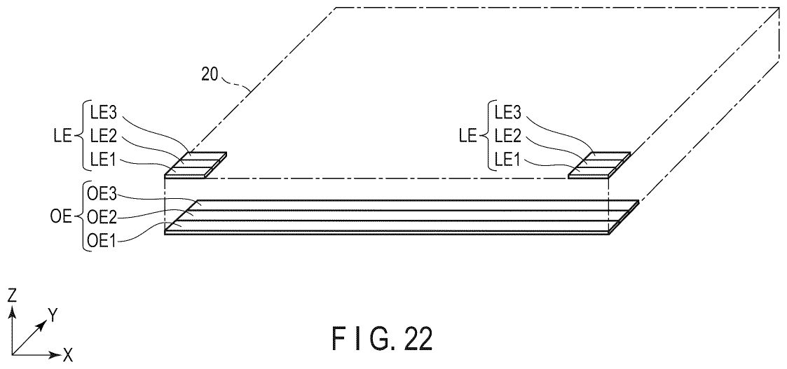

FIG. 22 is a diagram for explaining application example 3 of a liquid crystal element.

Application example 3 is different from application example 1 in respect that the diffractive element OE1, the diffractive element OE2 and the diffractive element OE3 are provided at different positions without overlapping each other. In the example shown in the figure, the diffractive element OE1, the diffractive element OE2 and the diffractive element OE3 are arranged in the second direction Y.

The light emitting element LE1, the light emitting element LE2 and the light emitting element LE3 are arranged in the second direction Y. The light emitting element LE1 overlaps the diffractive element OE1. The light emitting element LE2 overlaps the diffractive element OE2. The light emitting element LE3 overlaps the diffractive element OE3.

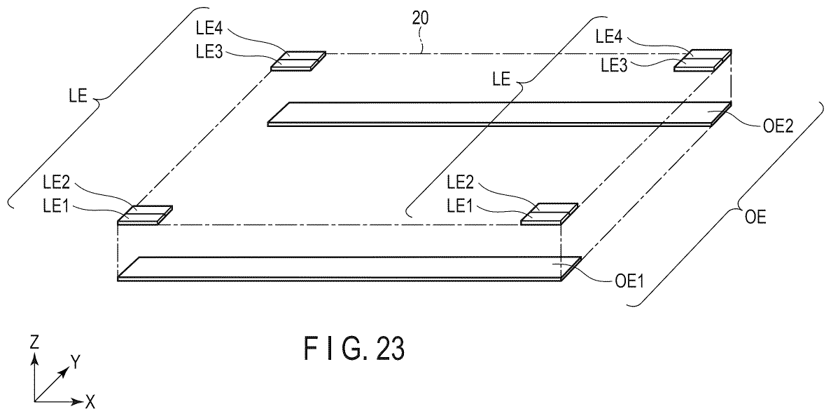

FIG. 23 is a diagram for explaining application example 4 of a liquid crystal element.

In application example 4, the diffractive optical element OE comprises a diffractive element OE1 and a diffractive element OE2. The diffractive element OE1 and the diffractive element OE2 extend in the first direction X and are arranged across an intervening space in the second direction Y. The wavelength ranges of diffraction of the diffractive elements OE1 and OE2 are broadened. For example, the diffractive element OE1 is configured to diffract illumination light having a wavelength range containing a blue component and a green component, and the diffractive element OE2 is configured to diffract illumination light having a wavelength range containing a green component and a red component.

The light emitting unit OE comprises a light emitting element LE1, a light emitting element LE2, a light emitting element LE3 and a light emitting element LE4. For example, the light emitting element LE1 is configured to emit light having the first wavelength range containing a blue component. The light emitting element LE2 is configured to emit light having the second wavelength range containing a green component. The light emitting element LE3 is configured to emit light having the second wavelength range containing a green component. The light emitting element LE4 is configured to emit light having the third wavelength range containing a red component

The light emitting element LE1 and the light emitting element LE2 are adjacent to each other and overlap the diffractive element OE1. The light emitting element LE3 and the light emitting element LE4 are adjacent to each other and overlap the diffractive element OE2. The light emitting element LE2 and the light emitting element LE3 are arranged across an intervening space in the second direction Y.

In the above application examples 1 to 4, for example, the light emitting element LE1 corresponds to the first light emitting element, and the light emitting element LE2 or the light emitting element LE3 corresponds to the second light emitting element. The diffractive element OE1 corresponds to the first diffractive element. The diffractive element OE2 corresponds to the second diffractive element. The diffractive element OE3 corresponds to the third diffractive element.

Now, this specification explains the specific cross-sectional structure of the display device 1. Here, configuration example 1 is explained. It should be noted that the illustrations of the various lines, insulating layers, switching elements and the like are omitted.

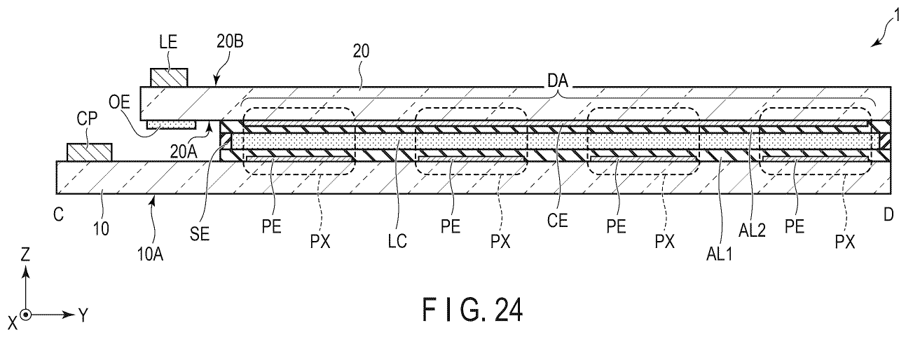

FIG. 24 is a cross-sectional view showing a configuration example of the display device 1 along the C-D line of FIG. 1.

The transparent substrate 10 and the transparent substrate 20 face each other in the third direction Z. The liquid crystal layer LC is located between the transparent substrate 10 and the transparent substrate 20 and sealed with the sealant SE. The pixel electrode PE of each pixel PX is located between the transparent substrate 10 and the liquid crystal layer LC and is covered with an alignment film AL1. A common electrode CE facing the pixel electrodes PE is located between the transparent substrate 20 and the liquid crystal layer LC and is covered with an alignment film AL2. The liquid crystal layer LC is in contact with the alignment film AL1 and the alignment film AL2.

Each of the transparent substrate 10 and the transparent substrate 20 may be a glass substrates or may be a resinous substrate. Each of the pixel electrodes PE and the common electrode CE is a transparent electrode formed of a transparent conductive material such as indium tin oxide (ITO).

The light emitting unit LE faces the diffractive optical element OE across the intervening substrate 20 in the third direction Z. The diffractive optical element OE faces, of the main surface 20A, the area which does not overlap the sealant SE. The light emitting unit LE faces, of the main surface 20B, the area which does not overlap the sealant SE.

Although not described in detail, the light emitting unit LE comprises a red light emitting unit, a green light emitting unit and a blue light emitting unit as light emitting elements. These red light emitting unit, green light emitting unit and blue light emitting unit may light up in series or all of them may light up at the same time. As described above, the diffractive optical element OE comprises a holographic optical element or a liquid crystal element containing a cholesteric liquid crystal.

In this display device 1, when voltage is applied to each pixel PX, illumination light emitted from the light emitting unit LE is scattered in the liquid crystal layer LC of each pixel PX. In a case where the liquid crystal layer LC is in a transparent state, when the display device 1 is observed from the main surface 10A side, the background can be observed through the display device 1, and similarly, when the display device 1 is observed from the main surface 20B side, the background can be observed through the display device 1.

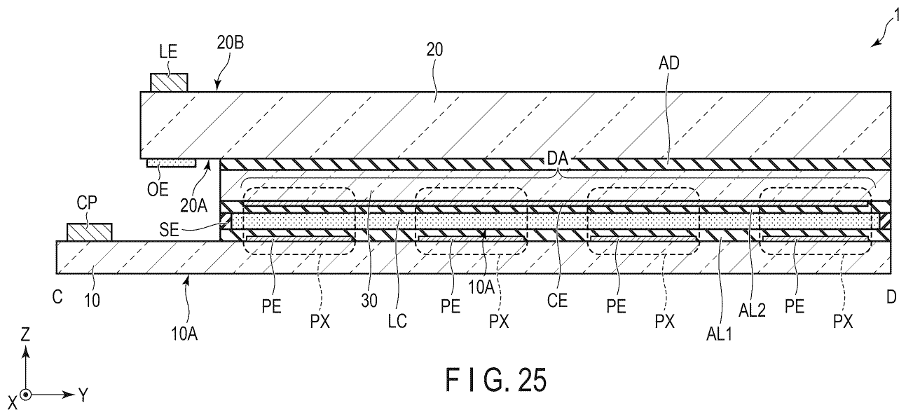

FIG. 25 is a cross-sectional view showing another configuration example of the display device 1 along the C-D line of FIG. 1.

The configuration example shown in FIG. 25 is different from that shown in FIG. 24 in respect that the display device 1 further comprises a transparent substrate 30. The transparent substrate 30 is located between the transparent substrate 10 and the transparent substrate 20 in the third direction Z. The liquid crystal layer LC is located between the transparent substrate 10 and the transparent substrate and sealed with the sealant SE. A common electrode CE facing a plurality of pixel electrodes PE is located between the transparent substrate 30 and the liquid crystal layer LC and is covered with the alignment film AL2. The transparent substrate 30 is attached to the main surface 20A of the transparent substrate 20 via a transparent adhesive layer AD. The adhesive layer AD has a refractive index equal to the refractive indices of the transparent substrate 20 and the transparent substrate 30. For this reason, undesired interface reflection is prevented between the transparent substrate 20 and the transparent substrate 30.

The light emitting unit LE faces the diffractive optical element OE across the intervening substrate 20 in the third direction Z. The diffractive optical element OE faces, of the main surface 20A, the area which does not overlap the transparent substrate 30. The light emitting unit LE faces, of the main surface 20B, the area which does not overlap the transparent substrate 30.

In this configuration example, the transparent substrate 20 functions as a cover member and is thicker than the transparent substrates 10 and which hold the liquid crystal layer LC between them.

It should be noted that, in each of the configuration examples shown in FIG. 24 and FIG. 25, the diffractive optical element OE may be provided on the main surface 10A of the transparent substrate 10.

Further, in the display device 1 shown in FIG. 20 to FIG. 25, the light emitting unit LE comprises a red light emitting unit, a green light emitting unit and a blue light emitting unit, and field sequential driving for displaying images by causing these red light emitting unit, green light emitting unit and blue light emitting unit to light up in series is used.

Now, several modified examples are explained.

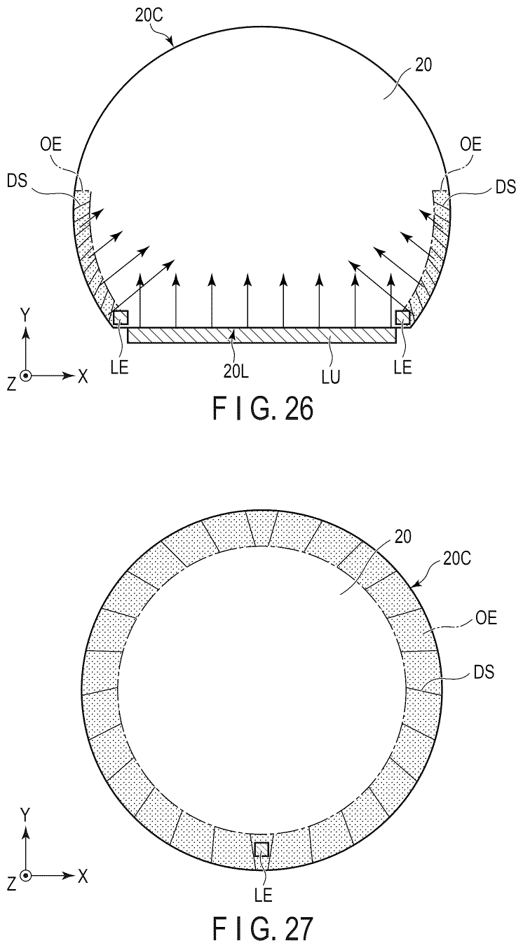

FIG. 26 is a plan view showing modified example 1.

The transparent substrate 20 is formed into substantially a semicircle in plan view. In the example shown in the figure, the transparent substrate has a linear edge portion 20L parallel to the first direction X, and an arcuate edge portion 20C. The light source unit LU is provided along the edge portion 20L.

The diffractive optical elements OE are provided along the edge portion 20C near the light source unit LU. For example, the diffractive optical elements OE face the main surface of the transparent substrate 20 in a manner similar to that of configuration example 1, etc. However, the diffractive optical elements OF may face the edge portion 20C of the transparent substrate 20.

Each light emitting unit LE overlaps an end portion of the corresponding diffractive optical element OE. It should be noted that the light emitting units LE may face the edge portion 20L or edge portion 20C of the transparent substrate 20.

FIG. 27 is a plan view showing modified example 2.

In modified example 2, the transparent substrate 20 is formed into a circular shape in plan view. The diffractive optical element OE is formed into an annular shape and faces the main surface of the transparent substrate 20 in a manner similar to that of configuration example 1, etc. However, the diffractive optical element OF may face the circular edge portion 20C of the transparent substrate 20. The light emitting unit LE overlaps the diffractive optical element OE. However, the light emitting unit LE may face the edge portion 20C. In the example shown in the figure, the number of light emitting units LE is one. However, the number of light emitting units LE may be greater than one.

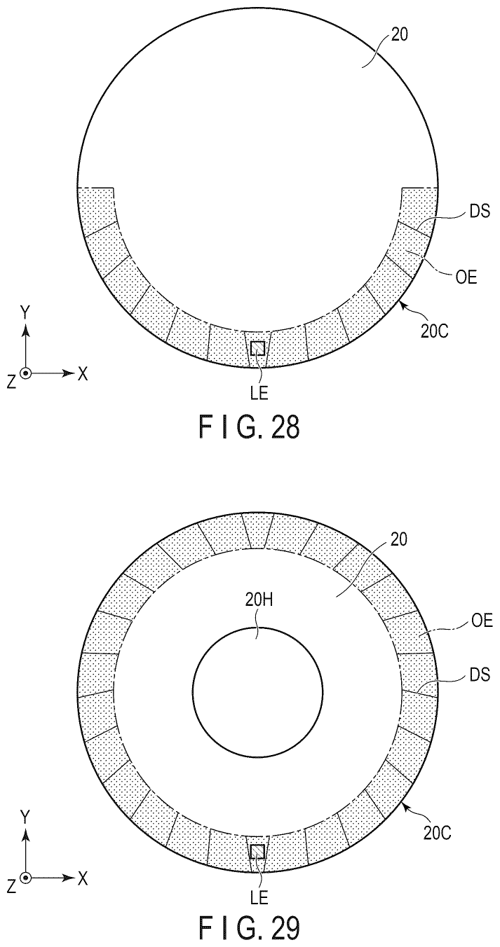

FIG. 28 is a plan view showing modified example 3.

Modified example 3 is different from modified example 2 in respect that the diffractive optical element OE is formed into a U-shape. The diffractive optical element OE faces the main surface of the transparent substrate 20. However, the diffractive optical element OE may face the circular edge portion 20C of the transparent substrate 20. The light emitting unit LE overlaps the diffractive optical element OE. However, the light emitting unit LE may face the edge portion 20C.

FIG. 29 is a plan view showing modified example 4.

Modified example 4 is different from modified example 2 in respect that the transparent substrate 20 is formed into an annular shape as seen in plan view. In other words, the transparent substrate 20 has a through hole 20H in the center. The diffractive optical element OE is formed into an annular shape. However, the diffractive optical element OE may be formed into a U-shape in a manner similar to that of modified example 3.

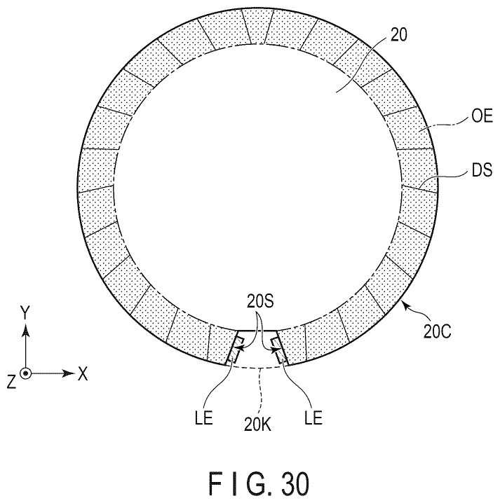

FIG. 30 is a plan view showing modified example 5.

Modified example 5 is different from modified example 2 in respect that the transparent substrate 20 has a notch portion 20K. The diffractive optical element OE is provided over almost the whole circumference of the transparent substrate 20 excluding the notch portion 20K. The diffractive optical element OE faces the main surface of the transparent substrate 20. However, the diffractive optical element OE may face the edge portion 20C of the transparent substrate 20. The light emitting units LE face the side surfaces 20S of the transparent substrate 20 in the notch portion 20K. However, the light emitting units LE may face the edge portion 20C or may face the main surface of the transparent substrate 20.

In these modified examples 1 to 5, light emitted from each light emitting unit LE is diffracted on the diffractive surface DS of the diffractive optical element OE, and almost the entire area of the transparent substrate 20 can be illuminated with the light regardless of the shape of the transparent substrate 20.

In the embodiment described above, for example, the transparent substrate 10 corresponds to the first transparent substrate. The transparent substrate 20 corresponds to the second transparent substrate. The transparent substrate 30 corresponds to the third transparent substrate.

The embodiment described above is explained by focusing attention on the configuration of the display device 1. However, it should be noted that the combination of the transparent substrate 20, the light emitting unit LE and the diffractive optical element OE can be configured as a light source device.

Each of the light emitting units LE shown in the examples may comprise, in addition to the light emitting elements, a light control element which controls the traveling direction of the light emitted from each light emitting element.

As explained above, the embodiment can provide a display device and a light source device such that the uniformity of luminance can be improved.

All of the display devices and light source devices that can be implemented by a person of ordinary skill in the art through arbitrary design changes to the display device and light source device described above as the embodiments of the present invention come within the scope of the present invention as long as they are in keeping with the spirit of the present invention.

Various modified examples which may be conceived by a person of ordinary skill in the art in the scope of the idea of the present invention will also fall within the scope of the invention. For example, even if a person of ordinary skill in the art arbitrarily modifies the above embodiments by adding or deleting a structural element or changing the design of a structural element, or by adding or omitting a step or changing the condition of a step, all of the modifications fall within the scope of the present invention as long as they are in keeping with the spirit of the invention.

Further, other effects which may be obtained from the above embodiments and are self-explanatory from the descriptions of the specification or can be arbitrarily conceived by a person of ordinary skill in the art are considered as the effects of the present invention as a matter of course.

Examples of the display device and the light source device obtained from the configuration disclosed in this specification are additionally described below.
(A) A display device comprising:
a first transparent substrate;
a second transparent substrate which has a first surface and a second surface different from the first surface;
a liquid crystal layer which is located between the first transparent substrate and the second transparent substrate and contains a polymer dispersed liquid crystal;
at least one light emitting unit configured to emit illumination light for illuminating the liquid crystal layer; and
a diffractive optical element which faces the first surface, is provided at a position which does not overlap the liquid crystal layer, and is configured to diffract the illumination light.
(B) The display device of (A), further comprising a sealant with which the liquid crystal layer is sealed between the first transparent substrate and the second transparent substrate, wherein
the diffractive optical element faces, of the first surface, an area which does not overlap the sealant.
(C) The display device of (B), further comprising:
a pixel electrode located between the first transparent substrate and the liquid crystal layer; and
a common electrode located between the second transparent substrate and the liquid crystal layer.
(D) The display device of (A), further comprising a third transparent substrate located between the first transparent substrate and the second transparent substrate, wherein
the liquid crystal layer is sealed between the first transparent substrate and the third transparent substrate,
the third transparent substrate is attached to a first main surface of the second transparent substrate, and
the diffractive optical element faces, of the first main surface, an area which does not overlap the third transparent substrate.
(E) The display device of (D), further comprising:
a pixel electrode located between the first transparent substrate and the liquid crystal layer; and
a common electrode located between the third transparent substrate and the liquid crystal layer.
(F) A light source device comprising:
a transparent substrate having a first surface and a second surface different from the first surface;
a light emitting unit configured to emit illumination light for illuminating the transparent substrate; and
a diffractive optical element facing the first surface and configured to diffract the illumination light.
(G) The light source device of (F), wherein
the first surface is a first main surface of the transparent substrate,
the second surface is a second main surface of the transparent substrate, and the second main surface is located on a side opposite to the first main surface, and
the light emitting unit faces the second surface.
(H) The light source device of (F), wherein
the first surface is a first main surface of the transparent substrate,
the second surface is a side surface of the transparent substrate, and the side surface intersects with the first main surface, and
the light emitting unit faces the second surface.
(I) The light source device of (F), further comprising a light guide, wherein
the first surface is a side surface of the transparent substrate,
the light guide is located between the transparent substrate and the diffractive optical element, and
the light emitting unit faces the light guide.

What is claimed is:

1. A display device comprising:
a first transparent substrate;
a second transparent substrate which has a first surface and a second surface different from the first surface;
a liquid crystal layer which is located between the first transparent substrate and the second transparent substrate and contains a polymer dispersed liquid crystal;
at least one light emitting unit configured to emit illumination light for illuminating the liquid crystal layer; and
a diffractive optical element which faces the first surface, is provided at a position which does not overlap the liquid crystal layer, and is configured to diffract the illumination light.

2. The display device of claim 1, wherein
the first surface is a first main surface of the second transparent substrate, and the first main surface faces the first transparent substrate,
the second surface is a second main surface of the second transparent substrate, and the second main surface is located on a side opposite to the first main surface, and
the light emitting unit faces the second surface.

3. The display device of claim 2, wherein
the diffractive optical element is formed into a belt-like shape, and
the light emitting unit overlaps an end portion of the diffractive optical element.

4. The display device of claim 2, wherein
the diffractive optical element is formed into a belt-like shape, and
a plurality of light emitting units overlap both end portions of the diffractive optical element.

5. The display device of claim 1, wherein
the first surface is a first main surface of the second transparent substrate, and the first main surface faces the first transparent substrate,
the second surface is a side surface of the second transparent substrate, and the side surface intersects with the first main surface, and
the light emitting unit faces the second surface.

6. The display device of claim 5, wherein
the diffractive optical element is formed into a belt-like shape, and
the light emitting unit is located on an end side of the diffractive optical element.

7. The display device of claim 5, wherein
the diffractive optical element is formed into a belt-like shape, and
a plurality of light emitting units are located on an end side and other end side of the diffractive optical element.

8. The display device of claim 3, wherein
in the diffractive optical element, a thickness of the end portion is less than a thickness of other end portion.

9. The display device of claim 3, wherein
in the diffractive optical element, a width of the end portion is less than a width of other end portion.

10. The display device of claim 1, further comprising a light guide, wherein
the light guide is located between the second transparent substrate and the diffractive optical element, and
the light emitting unit faces the light guide.

11. The display device of claim 10, wherein
the light guide has a first side surface facing a side surface of the second transparent substrate, and a second side surface intersecting with the first side surface, and
the light emitting unit faces an end portion of the second side surface of the light guide.

12. The display device of claim 10, wherein
the light guide has a first side surface facing a side surface of the second transparent substrate, and a second side surface intersecting with the first side surface, and
a plurality of light emitting units face both end portions of the second side surface of the light guide.

13. The display device of claim 10, wherein
the light guide has a first side surface facing a side surface of the second transparent substrate, and a first end surface intersecting with the first side surface, and
the light emitting unit faces the first end surface of the light guide.

14. The display device of claim 10, wherein
the light guide has a first side surface facing a side surface of the second transparent substrate, a first end surface intersecting with the first side surface, and a second end surface located on a side opposite to the first end surface, and
a plurality of light emitting units face the first and second end surfaces of the light guide.

15. The display device of claim 1, wherein
the light emitting unit comprises:
a first light emitting element configured to emit light having a first wavelength range; and
a second light emitting element configured to emit light having a second wavelength range different from the first wavelength range, and
the diffractive optical element comprises:
a first diffractive element configured to diffract the illumination light having the first wavelength range; and
a second diffractive element configured to diffract the illumination light having the second wavelength range.

16. The display device of claim 15, wherein
the first diffractive element and the second diffractive element are stacked, and
each of the first light emitting element and the second light emitting element overlaps the first diffractive element and the second diffractive element.

17. The display device of claim 15, wherein
the first diffractive element is provided at a position different from the second diffractive element,
the first light emitting element overlaps the first diffractive element, and
the second light emitting element overlaps the second diffractive element.

18. The display device of claim 1, wherein
the diffractive optical element comprises a holographic optical element or a liquid crystal element containing a cholesteric liquid crystal.

19. The display device of claim 6, wherein
in the diffractive optical element, a thickness of an end portion is less than a thickness of other end portion.

20. The display device of claim 6, wherein
in the diffractive optical element, a width of an end portion is less than a width of other end portion.
